(19) United States
(12) Patent Application Publication
(10) Pub. No.: US 2024/0154097 A1
(43) Pub. Date: May 9, 2024

(54) SANDWICH-STRUCTURED, PRE-LITHIATED ANODE ELECTRODE FOR ALL-SOLID-STATE BATTERY

(71) Applicant: GM Global Technology Operations LLC, Detroit, MI (US)

(72) Inventors: Qili Su, Shanghai (CN); Zhe Li, Shanghai (CN); Yong Lu, Shanghai (CN); Haijing Liu, Shanghai (CN)

(21) Appl. No.: 18/128,625

(22) Filed: Mar. 30, 2023

(30) Foreign Application Priority Data
Nov. 8, 2022 (CN) 202211391211.3

(51) Int. Cl. H01M 4/36; H01M 4/131; H01M 4/133; H01M 4/136; H01M 4/48; H01M 4/485; H01M 4/58; H01M 4/587; H01M 4/62

(52) U.S. Cl. CPC H01M 4/366; H01M 4/131; H01M 4/133; H01M 4/136; H01M 4/48; H01M 4/485; H01M 4/5815; H01M 4/587; H01M 4/622; H01M 4/623; H01M 4/625; H01M 2004/027

(57) ABSTRACT

An anode electrode includes a current collector and a first anode layer arranged on the current collector and comprising first anode active material. A first pre-lithiation layer is arranged on the first anode layer. A second anode layer arranged on the first pre-lithiation layer and comprising second anode active material.

### CROSS-REFERENCE TO RELATED APPLICATIONS

This application claims the benefit of Chinese Patent Application No. 202211391211.3, filed on Nov. 8, 2022. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to a sandwich-structured, pre-lithiated anode electrode for an all-solid-state battery.

Electric vehicles (EVs) such as battery electric vehicles (BEVs), hybrid vehicles, and/or fuel cell vehicles include one or more electric machines and a battery system including one or more battery cells, modules and/or packs. A power control system is used to control charging and/or discharging of the battery system during charging and/or driving. Manufacturers of EVs are pursuing increased power density to increase the range of the EVs.

Lithium-ion battery (LIB) cells are currently used for high power density applications. All-solid-state battery (ASSB) cells have improved characteristics compared to LIB cells in terms of abuse tolerance, power capability and/or working temperature range.

### SUMMARY

An anode electrode includes a current collector and a first anode layer arranged on the current collector and comprising first anode active material. A first pre-lithiation layer is arranged on the first anode layer. A second anode layer arranged on the first pre-lithiation layer and comprising second anode active material.

In other features, a second pre-lithiation layer is arranged on the second anode layer. A third anode layer is arranged on the second pre-lithiation layer and comprising third anode active material. The first anode active material is selected from a group consisting of carbonaceous material, a metal oxide/sulfide, a lithium alloy-type material, and combinations thereof. The first pre-lithiation layer is selected from a group consisting of lithium foil, stabilized lithium metal powder (SLMP), and lithium-doped material.

In other features, the first anode layer has a thickness in a range from 5 μm to 200 μm, and the first pre-lithiation layer has a thickness in a range from 20 μm to 100 μm.

In other features, the first anode layer includes the first anode active material in a range from 30 to 100 wt %, sulfide electrolyte in a range from 1 to 50 wt %, and a first binder in a range from 1 to 20 wt %. The first anode active material is selected from a group consisting of carbonaceous material, a metal oxide/sulfide material, a lithium alloy-type material, and combinations thereof. The sulfide electrolyte is selected from a group consisting of pseudobinary sulfide, pseudoternary sulfide, pseudoquaternary sulfide, a halide-based sulfide electrolyte, a hydride-based sulfide electrolyte, and combinations thereof. The first binder is selected from a group consisting of poly(vinylidene fluoride) (PVDF), poly(vinylidene fluoride-co-hexafluoropropylene) (PVdF-HFP), poly(tetrafluoroethylene) (PTFE), sodium carboxymethyl cellulose (CMC), styrene-butadiene rubber (SBR), nitrile butadiene rubber (NBR), styrene ethylene butylene styrene copolymer (SEBS), and combinations thereof.

In other features, the second anode layer comprises the second anode active material in a range from 30 to 100 wt %, sulfide electrolyte in a range from 1 to 50 wt %, a first conductive additive in a range from 1 to 30 wt %, and a fibrillating polymer binder in a range from 1 to 20 wt %. The fibrillating polymer binder is selected from a group consisting of polytetrafluoroethylene (PTFE), fluorinated ethylene propylene (FEP), perfluoroalkoxy (PFA), ethylene tetrafluoroethylene (ETFE), or a combination thereof. The first conductive additive is selected from a group consisting of carbon black, graphite, graphene, graphene oxide, Super P, acetylene black, carbon nanofibers, carbon nanotubes, and combinations thereof.

A battery cell comprises the anode electrode, an electrolyte layer arranged adjacent to the anode electrode, a cathode electrode arranged adjacent to the electrolyte layer, and a second current collector arranged adjacent to the cathode electrode.

In other features, the cathode electrode includes sulfide electrolyte in a range from 1 to 50 wt %, cathode active material in a range from 30 to 98 wt %, a first conductive additive in a range from 1 to 30 wt %, and a first binder in a range from 1 to 20 wt %. The cathode electrode includes cathode active material selected from a group consisting of rock salt layered oxides, low voltage cathode material, surface-coated active materials, doped cathode active materials and combinations thereof.

In other features, the first conductive additive is selected from a group consisting of carbon black, graphite, graphene, graphene oxide, Super P, acetylene black, carbon nanofibers, carbon nanotubes and combinations thereof. The first binder is selected from a group consisting of polytetrafluoroethylene (PTFE), sodium carboxymethyl cellulose (CMC), styrene-butadiene rubber (SBR), poly(vinylidene fluoride) (PVDF), nitrile butadiene rubber (N BR), styrene ethylene butylene styrene copolymer (SEBS), styrene butadiene styrene copolymer (SBS), and combinations thereof.

A battery cell comprises a first current collector. An anode electrode includes a first anode layer arranged on the first current collector and comprising first anode active material in a range from 30 to 100 wt %, sulfide electrolyte in a range from 1 to 50 wt %, and a first binder in a range from 1 to 20 wt %. A first pre-lithiation layer is arranged on the first anode layer. The first pre-lithiation layer is selected from a group consisting of lithium foil, stabilized lithium metal powder (SLMP), a lithium-doped material, and combinations thereof. A second anode layer is arranged on the first pre-lithiation layer and comprises second anode active material in a range from 30 to 100 wt %, sulfide electrolyte in a range from 1 to 50 wt %, a first conductive additive in a range from 1 to 30 wt %, and a fibrillating polymer binder in a range from 1 to 20 wt %. A electrolyte layer is arranged adjacent to the anode electrode. A cathode electrode is arranged adjacent to the electrolyte layer. A second current collector is arranged adjacent to the cathode electrode.

In other features, the first anode active material is selected from a group consisting of carbonaceous material, a metal oxide/sulfide, a lithium alloy-type material, and combinations thereof. The first binder is selected from a group consisting of poly(vinylidene fluoride) (PVDF), poly(vinylidene fluoride-co-hexafluoropropylene) (PVdF-HFP), poly(tetrafluoroethylene) (PTFE), sodium carboxymethyl cellulose (CMC), styrene-butadiene rubber (SBR), nitrile butadiene rubber (NBR), styrene ethylene butylene styrene copolymer (SEBS), and combinations thereof.

In other features, the fibrillating polymer binder is selected from a group consisting of polytetrafluoroethylene (PTFE), fluorinated ethylene propylene (FEP), perfluoroalkoxy (PFA), ethylene tetrafluoroethylene (ETFE), or a combination thereof. The first conductive additive is selected from a group consisting of carbon black, graphite, graphene, graphene oxide, Super P, acetylene black, carbon nanofibers, carbon nanotubes, and combinations thereof.

In other features, the cathode electrode includes sulfide electrolyte in a range from 1 to 50 wt %, cathode active material in a range from 30 to 98 wt %, a conductive additive in a range from 1 to 30 wt %, and binder in a range from 1 to 20 wt %. The cathode electrode includes cathode active material selected from a group consisting of rock salt layered oxides, low voltage cathode material, and surface-coated active materials, doped cathode active materials and combinations thereof.

In other features, the conductive additive is selected from a group consisting of carbon black, graphite, graphene, graphene oxide, Super P, acetylene black, carbon nanofibers, carbon nanotubes and combinations thereof. The binder is selected from a group consisting of polytetrafluoroethylene (PTFE), sodium carboxymethyl cellulose (CMC), styrene-butadiene rubber (SBR), poly(vinylidene fluoride) (PVDF), nitrile butadiene rubber (N BR), styrene ethylene butylene styrene copolymer (SEBS), styrene butadiene styrene copolymer (SBS), and combinations thereof.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross-sectional view of an example of an anode electrode and a lithium metal layer;

FIGS. 2A to 2C are side cross-sectional views of an example of an ASSB with the anode electrode and the lithium metal layer before forming pressure, after forming pressure, and after being fully pre-lithiated;

FIGS. 3A and 3B are side cross-sectional views of an example of a sandwich-structured, pre-lithiated anode electrode before and after pressing according to the present disclosure;

FIGS. 4A and 4B are side cross-sectional views of an example of a sandwich-structured, pre-lithiated anode electrode before and after pressing according to the present disclosure; and

FIGS. 5 to 8 are side cross-sectional views of examples of sandwich-structured, pre-lithiated anode electrodes according to the present disclosure.

In the drawings, reference numbers may be reused to identify similar and/or identical elements.

### DETAILED DESCRIPTION

While the battery cells according to the present disclosure are described below in the context of a vehicle, the battery cells according to the present disclosure can be used in other applications.

An all-solid-state battery (ASSB) includes anode electrodes including a lithium metal layer arranged between two anode active material layers to form a sandwich-structured pre-lithiated anode electrode. This arrangement is compatible with existing manufacturing equipment (e.g., roll to roll pressing) and allows tunable anode pre-lithiation by adjusting pre-lithiation layer thickness. This arrangement also increases the efficiency of lithium utilization by increasing a Li/anode material reaction surface area. As a result, an ASSB with the sandwich-structured pre-lithiated anode electrode can effectively compensate for the loss of active lithium to enhance the cycling performance of the ASSB.

All-solid-state battery (ASSB) cells with sulfide electrolyte have improved characteristics compared to current lithium-ion battery (LIB) cells in terms of abuse tolerance, power capability and/or working temperature range. However, thermodynamically unstable sulfides inevitably decompose. For example, Li₆PS₅Cl is only stable within a voltage range from 1.9V to 2.3V as compared to Li/Li⁺. Irreversible Li⁺ ion insertion or extraction for the sulfide contacting the cathode surface, anode surface, or current collector may also occur.

Referring now to FIG. 1, an example of an anode electrode 20 including a current collector 28, an anode layer 24 arranged on the current collector 28, and a pre-lithiation layer 32 such as lithium foil or powder is shown.

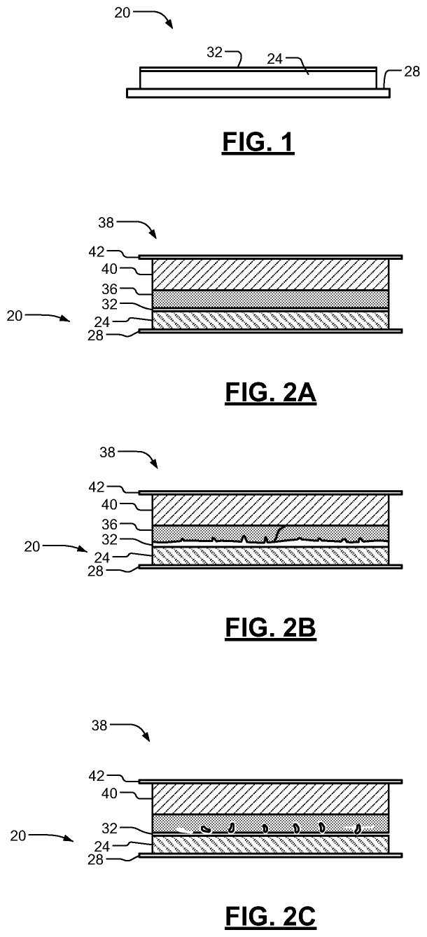

Referring now to FIGS. 2A to 2C, an example of an ASSB 38 including the anode electrode 20 is shown. The ASSB 38 further includes a sulfide electrolyte layer 36 arranged on the pre-lithiation layer 32. The ASSB 38 includes cathode active material 40 arranged on the sulfide electrolyte layer 36 and a current collector 42 arranged on the cathode active material 40.

In FIG. 2A, the ASSB 38 is shown before forming pressure. In FIG. 2B, the ASSB 38 is shown after forming pressure. Typical forming pressure is greater than 300 Mpa and battery forming time is around 4 to 6 minutes. In FIG. 2C, the ASSB 38 is shown after being fully pre-lithiated.

There are technical challenges with this manufacturing approach. During manufacturing, the lithium layer may adhere to rollers, calendaring rollers, pressing machines, and/or other equipment. Creep deformation of the lithium layer due to compression (as shown in FIG. 2B) may lead to mechanically induced cell shorting. Void formation and embedment of lithium in the sulfide electrolyte layer may occur (as shown in FIG. 2C).

Referring now to FIGS. 3A and 3B, an example of a sandwich-structured, pre-lithiated anode electrode 110 is shown. In FIG. 3A, the sandwich-structured, pre-lithiated anode electrode 100 is shown before pressing and includes a first anode layer 124 arranged on a current collector 120, a first pre-lithiation layer 128 arranged on the first anode layer 124, and a second anode layer 132 arranged on the first pre-lithiation layer 128.

In some examples, the first anode layer 124 includes a traditional solid-state anode electrode having a thickness in a range from 5 μm to 200 μm. In some examples, the first anode layer 124 includes anode active material in a range from 30 to 100 wt %, sulfide electrolyte in a range from 1 to 50 wt %, and a binder in a range from 1 to 20 wt %.

In some examples, the second anode layer 132 comprises a free-standing solid-state membrane having sufficient strength to be rolled, handled, and unrolled within an electrode fabrication process without other supporting layers.

In some examples, the second anode layer 132 has a thickness in the range from 10 μm to 200 μm. In some examples, the second anode layer 132 is solvent free. In some examples, the second anode layer 132 includes an alloying-type anode film (such as indium (In) foil). In some examples, the second anode layer 132 has high polymer content. In FIG. 3B, the sandwich-structured, pre-lithiated anode electrode is shown after pressing. As can be seen, pressing may cause distortion of one or more layers of the anode electrode.

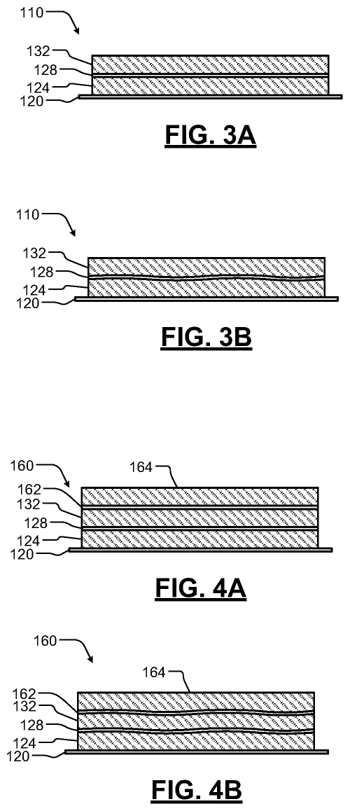

Referring now to FIGS. 4A and 4B, an example of a sandwich-structured, pre-lithiated anode electrode 160 is shown. In FIG. 4A, the sandwich-structured, pre-lithiated anode electrode 160 is shown before pressing and includes the first anode layer 124, the first pre-lithiation layer 128, the second anode layer 132, a second pre-lithiation layer 162 and a third anode layer 164.

In FIG. 4B, the sandwich-structured, pre-lithiated anode electrode 160 is shown after pressing. Some distortion of the first pre-lithiation layer 128 and the second pre-lithiation layer 162 may occur due to battery forming pressure. More generally, the sandwich-structured, pre-lithiated anode electrode 160 may include L anode active material layers (where L is an integer greater than one) and L−1 pre-lithiation layers. As can be appreciated, the L anode active material layers can use the same or different chemistry and/or have the same or different thicknesses.

The first and/or second pre-lithiation layers 128, 162 are protected during battery forming pressure by the anode layers 124, 132, and 164 without deteriorating the sulfide electrolyte layer. The prelitigation layer can be pressurized under solid-state battery forming pressure since lithium deformation is constrained within the lithium reaction anode active material. Pre-lithiation is completed during battery forming without leaving voids within the anode electrode, which enhances battery performance. Due to effective pre-lithiation produced by this approach, the battery cell with the sandwiched pre-lithiated anode electrode exhibits higher capacity and enhanced performance as compared to similar battery cells without pre-lithiation.

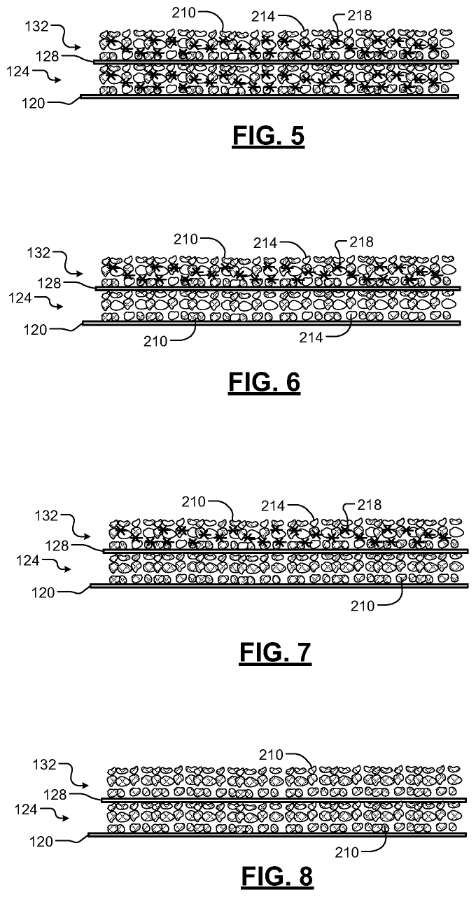

Referring now to FIGS. 5 to 8, examples of sandwich-structured, pre-lithiated anode electrodes are shown. In FIG. 5, the first anode layer 124 and the second anode layer 132 are shown to include electrode material 210, sulfide electrolyte 214, and polytetrafluoroethylene (PTFE) fibrils 218.

In FIG. 6, the first anode layer 124 includes the electrode material 210, the sulfide electrolyte 214, and the polytetrafluoroethylene (PTFE) fibrils 218. The second anode layer 132 includes the electrode material 210 and the sulfide electrolyte 214.

In FIG. 7, the first anode layer 124 includes the electrode material 210, the sulfide electrolyte 214, and the polytetrafluoroethylene (PTFE) fibrils 218. The second anode layer 132 includes the electrode material 210.

In FIG. 8, the first anode layer 124 and the second anode layer 132 include the electrode material 210.

In some examples, the first anode active material layer 124 comprises a free-standing dry anode or a wet-coated anode. In some examples, the first anode layer 124 has a thickness in a range from 5 μm to 200 μm. In some examples, the first anode layer 124 includes anode active material in a range from 30 to 100 wt %, sulfide electrolyte in a range from 1 to 50 wt %, and a binder in a range from 1 to 20 wt %.

In some examples, the first anode active material layer 124 comprises anode active material selected from a group consisting of carbonaceous material (e.g., graphite, hard carbon, soft carbon etc.), metal oxide/sulfide ((e.g., TiO₂, FeS, or similar), Li₄Ti₅O₁₂, or other lithium-accepting anode materials), lithium alloy-type material (e.g., silicon, transition-metals (e.g., tin (Sn), indium (In)), or combinations thereof.

In some examples, the first anode active material layer 124 comprises conductive additive selected from a group consisting of carbon black, graphite, graphene, graphene oxide, Super P, acetylene black, carbon nanofibers, carbon nanotubes, other electronically conductive additives, and combinations thereof.

In some examples, the first anode active material layer 124 comprises binder materials selected from a group consisting of poly(vinylidene fluoride) (PVDF), poly(vinylidene fluoride-co-hexafluoropropylene) (PVdF-HFP), poly(tetrafluoroethylene) (PTFE), sodium carboxymethyl cellulose (CMC), styrene-butadiene rubber (SBR), nitrile butadiene rubber (NBR), styrene ethylene butylene styrene copolymer (SEBS), and combinations thereof.

In some examples, the second anode active material layer 134 is a free-standing membrane that has sufficient strength to be rolled, handled, and unrolled within an electrode fabrication process without other supporting elements. In some examples, the second anode active material layer 134 has a thickness in a range from 20 μm to 200 um.

In some examples, the second anode active material layer 134 comprises a solvent-free solid-state membrane and includes anode active material in a range from 30 to 100 wt %, sulfide electrolyte in a range from 1 to 50 wt %, conductive additive in a range from 1 to 30 wt %, and a fibrillating polymer binder in a range from 1 to 20 wt %.

In some examples, the fibrillating polymer binder is selected from a group consisting of polytetrafluoroethylene (PTFE) binder, fluorinated ethylene propylene (FEP), perfluoroalkoxy (PFA), ethylene tetrafluoroethylene (ETFE), or a combination thereof. When used, the fibrillating polymer binder produces fibrils during pressing that help to hold the second anode active material layer together.

In some examples, the second anode active material layer 134 comprises anode active material selected from a group consisting of carbonaceous material (e.g., graphite, hard carbon, soft carbon etc.), metal oxide/sulfide ((e.g., TiO₂, FeS, or similar), Li₄Ti₅O₁₂, or other lithium-accepting anode materials), lithium alloy-type material (e.g., silicon, transition-metals (e.g., tin (Sn), indium (In)), or combinations thereof.

In some examples, the second anode active material layer 134 comprises conductive additive selected from a group consisting of carbon black, graphite, graphene, graphene oxide, Super P, acetylene black, carbon nanofibers, carbon nanotubes, other electronically conductive additives, and combinations thereof.

In other examples, the second anode active material layer 134 comprises an alloying-type anode film selected from a group consisting of pure alloy-type anode film (100 wt %), Li alloy-type semiconductor material (e.g., silicon film), Li alloy-type metal film (e.g., Sn, In film).

In other examples, the second anode active material layer 134 comprises a high polymer content film including anode active material in a range from 1 to 50 wt %, sulfide electrolyte in a range from 1 to 50 wt %, a conductive additive in a range from 1 to 30 wt %, and polymer binder greater than >50 wt %. In some examples, polymer binder materials are selected from a group consisting of poly(vinylidene fluoride) (PVDF), poly(vinylidene fluoride-cohexafluoropropylene) (PVdF-HFP), poly(tetrafluoroethylene) (PTFE), sodium carboxymethyl cellulose (CMC), styrene-butadiene rubber (SBR), nitrile butadiene rubber (NBR), styrene ethylene butylene styrene copolymer (SEBS), and combinations thereof.

In some examples, the one or more pre-lithiation layers are integrated between a first solid-state anode layer and a second solid-state anode layer, which provide active Li-sources for anode pre-lithiation. In some examples, the one or more pre-lithiation layers are selected from a group consisting of lithium foil, stabilized lithium metal powder (SLMP), and lithium-doped material (e.g., Li/AI alloy, Li doped silicon or silicon oxide (SiO) or silicon compound).

In some examples, the one or more pre-lithiation layers comprise a free-standing Li foil having a thickness in a range from 20 um to 100 um. In some examples, the one or more pre-lithiation layers fully or partially cover area between the first anode layer and the second anode layer to achieve a predetermined pre-lithiation amount.

In other examples, the one or more pre-lithiation layers are coated on the first anode layer and have a thickness in a range from 2 um to 100 um. In some examples, the one or more pre-lithiation layers comprise SLMP coated on the first anode layer.

In some examples, the sulfide electrolyte layer comprises a sulfide-based sulfide electrolyte selected from a group consisting of pseudobinary sulfide, pseudoternary sulfide, and pseudoquaternary sulfide. Examples of pseudobinary sulfide include Li₂S—P₂S₅ system (e.g., Li₃PS₄, Li₇P₃S₁₁ and Li_{9.6}P₃S₁₂), Li₂S—SnS₂ system (e.g., Li₄SnS₄), Li₂S—SiS₂ system, Li₂S—GeS₂ system, Li₂S—B₂S₃ system, Li₂S—Ga₂S₃ system, Li₂S—P₂S₃ system, and Li₂S—Al₂S₃ system. Examples of pseudoternary sulfide include Li₂O—Li₂S—P₂S₅ system, Li₂S—P₂S₅—P₂O₅ system, Li₂S—P₂S₅—GeS₂ system (Li_{3.25}Ge_{0.25}P_{0.75}S₄ and Li₁₀GeP₂S₁₂), Li₂S—P₂S₅—LiX (X=F, Cl, Br, I) system (Li₆PS₅Br, Li₆PS₅Cl, L₇P₂S₈I and Li₄PS₄I), Li₂S—As₂S₅—SnS₂ system (Li_{3.833}Sn_{0.833}As_{0.166}S₄), Li₂S—P₂S₅—Al₂S₃ system, Li₂S—LiX—SiS₂ (X=F, Cl, Br, I) system, 0.4LiI·0.6Li₄SnS₄ and Li₁₁Si₂PS₁₂. Examples of pseudoquaternary sulfide include Li₂O—Li₂S—P₂S₅—P₂O₅ system, Li_{9.54}Si_{1.74}P_{1.44}S_{11.7}Cl_{0.3}, Li₇P_{2.9}Mn_{0.1}S_{10.7}I_{0.3}, and Li_{10.3}[Sn_{0.21}Si_{1.08}]P_{1.65}S₁₂.

In some examples, the sulfide electrolyte layer includes a halide-based sulfide electrolyte, a hydride-based sulfide electrolyte, or other sulfide electrolyte with low grain-boundary resistance. Examples of the halide-based sulfide electrolyte include Li₃YCl₆, Li₃InCl₆, Li₃YBr₆, Lil, Li₂CdC₁₄, Li₂MgCl₄, Li₂Cd₁₄, Li₂Zn₁₄, and Li₃OCl. Examples of the hydride-based sulfide electrolyte include LiBH₄, LiBH₄—LiX (X=CI, Br or I), LiNH₂, Li₂NH, LiBH₄—LiNH₂, and Li₃AlH₆.

In some examples, a cathode electrode comprises sulfide electrolyte in a range from 1 to 50 wt %, cathode active material in a range from 30 to 98 wt %, a conductive additive in a range from 1 to 30 wt %, and binder in a range from 1 to 20 wt %. In some examples, the cathode electrode has a thickness in a range from 10 μm to 500 um (e.g., 40 μm).

In some examples, a cathode active material is selected from a group consisting of rock salt layered oxides, low voltage cathode material, and surface-coated and/or doped cathode active materials. Examples of rock salt layered oxides include LiCoO₂, LiNiₓMn_{y}Co_{1-x-y}O₂₁, LiNiₓMn_{y}Al_{1-x-y}O₂, LiNiₓMn₁₋ₓO₂, spinel (LiMn₂O₄, LiNi_{0.5}Mn_{1.5}O₄), polyanion cathode (LiV₂(PO₄)₃), olivine cathode (LiFePO₄ and LiMnₓFe₁₋ₓPO₄), and other lithium transition-metal oxides. Examples of surface-coated and/or doped cathode materials described above (e.g., LiNbO₃ coated LiMn₂O₄, Li₂ZrO₃ or Li₃PO₄-coated LiNiₓMn_{y}Co_{1-x-y}O₂, and Al-doped LiMn₂O₄. Examples of low voltage cathode materials include lithiated metal oxide/sulfide (e.g., LiTiS₂), lithium sulfide, sulfur, and combinations thereof.

In some examples, the conductive additive is selected from a group consisting of carbon black, graphite, graphene, graphene oxide, Super P, acetylene black, carbon nanofibers, carbon nanotubes and other electronically conductive additives. In some examples, the binder is selected from a group consisting of polytetrafluoroethylene (PTFE), sodium carboxymethyl cellulose (CMC), styrene-butadiene rubber (SBR), poly(vinylidene fluoride) (PVDF), nitrile butadiene rubber (N BR), styrene ethylene butylene styrene copolymer (SEBS), styrene butadiene styrene copolymer (SBS), and combinations thereof.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. An anode electrode, comprising:
a current collector;
a first anode layer arranged on the current collector and comprising first anode active material;
a first pre-lithiation layer arranged on the first anode layer; and
a second anode layer arranged on the first pre-lithiation layer and comprising second anode active material.

2. The anode electrode of claim 1, further comprising:
a second pre-lithiation layer arranged on the second anode layer; and
a third anode layer arranged on the second pre-lithiation layer and comprising third anode active material.

3. The anode electrode of claim 1, wherein:
the first anode active material is selected from a group consisting of carbonaceous material, a metal oxide/sulfide, a lithium alloy-type material, and combinations thereof, and
the first pre-lithiation layer is selected from a group consisting of lithium foil, stabilized lithium metal powder (SLMP), and lithium-doped material.

4. The anode electrode of claim 1, wherein:
the first anode layer has a thickness in a range from 5 μm to 200 μm, and
the first pre-lithiation layer has a thickness in a range from 20 μm to 100 μm.

5. The anode electrode of claim 1, wherein the first anode layer includes the first anode active material in a range from 30 to 100 wt %, sulfide electrolyte in a range from 1 to 50 wt %, and a first binder in a range from 1 to 20 wt %.

6. The anode electrode of claim 5, wherein the first anode active material is selected from a group consisting of carbonaceous material, a metal oxide/sulfide material, a lithium alloy-type material, and combinations thereof.

7. The anode electrode of claim 5, wherein the sulfide electrolyte is selected from a group consisting of pseudobinary sulfide, pseudoternary sulfide, pseudoquaternary sulfide, a halide-based sulfide electrolyte, a hydride-based sulfide electrolyte, and combinations thereof.

8. The anode electrode of claim 5, wherein the first binder is selected from a group consisting of poly(vinylidene fluoride) (PVDF), poly(vinylidene fluoride-co-hexafluoropropylene) (PVdF-HFP), poly(tetrafluoroethylene) (PTFE), sodium carboxymethyl cellulose (CMC), styrene-butadiene rubber (SBR), nitrile butadiene rubber (NBR), styrene ethylene butylene styrene copolymer (SEBS), and combinations thereof.

9. The anode electrode of claim 1, wherein the second anode layer comprises the second anode active material in a range from 30 to 100 wt %, sulfide electrolyte in a range from 1 to 50 wt %, a first conductive additive in a range from 1 to 30 wt %, and a fibrillating polymer binder in a range from 1 to 20 wt %.

10. The anode electrode of claim 9, wherein the fibrillating polymer binder is selected from a group consisting of polytetrafluoroethylene (PTFE), fluorinated ethylene propylene (FEP), perfluoroalkoxy (PFA), ethylene tetrafluoroethylene (ETFE), or a combination thereof.

11. The anode electrode of claim 9, wherein the first conductive additive is selected from a group consisting of carbon black, graphite, graphene, graphene oxide, Super P, acetylene black, carbon nanofibers, carbon nanotubes, and combinations thereof.

12. A battery cell comprising:
the anode electrode of claim 1;
an electrolyte layer arranged adjacent to the anode electrode;
a cathode electrode arranged adjacent to the electrolyte layer; and
a second current collector arranged adjacent to the cathode electrode.

13. The battery cell of claim 12, wherein the cathode electrode includes sulfide electrolyte in a range from 1 to 50 wt %, cathode active material in a range from 30 to 98 wt %, a first conductive additive in a range from 1 to 30 wt %, and a first binder in a range from 1 to 20 wt %.

14. The battery cell of claim 13, wherein the cathode electrode includes cathode active material selected from a group consisting of rock salt layered oxides, low voltage cathode material, surface-coated active materials, doped cathode active materials and combinations thereof.

15. The battery cell of claim 13, wherein:
the first conductive additive is selected from a group consisting of carbon black, graphite, graphene, graphene oxide, Super P, acetylene black, carbon nanofibers, carbon nanotubes and combinations thereof, and
the first binder is selected from a group consisting of polytetrafluoroethylene (PTFE), sodium carboxymethyl cellulose (CMC), styrene-butadiene rubber (SBR), poly(vinylidene fluoride) (PVDF), nitrile butadiene rubber (N BR), styrene ethylene butylene styrene copolymer (SEBS), styrene butadiene styrene copolymer (SBS), and combinations thereof.

16. A battery cell comprising:
a first current collector;
an anode electrode comprising:
a first anode layer arranged on the first current collector and comprising first anode active material in a range from 30 to 100 wt %, sulfide electrolyte in a range from 1 to 50 wt %, and a first binder in a range from 1 to 20 wt %;
a first pre-lithiation layer arranged on the first anode layer, wherein the first pre-lithiation layer is selected from a group consisting of lithium foil, stabilized lithium metal powder (SLMP), a lithium-doped material, and combinations thereof;
a second anode layer arranged on the first pre-lithiation layer and comprising second anode active material in a range from 30 to 100 wt %, sulfide electrolyte in a range from 1 to 50 wt %, a first conductive additive in a range from 1 to 30 wt %, and a fibrillating polymer binder in a range from 1 to 20 wt %;
an electrolyte layer arranged adjacent to the anode electrode;
a cathode electrode arranged adjacent to the electrolyte layer; and
a second current collector arranged adjacent to the cathode electrode.

17. The battery cell of claim 16, wherein:
the first anode active material is selected from a group consisting of carbonaceous material, a metal oxide/sulfide, a lithium alloy-type material, and combinations thereof, and
the first binder is selected from a group consisting of poly(vinylidene fluoride) (PVDF), poly(vinylidene fluoride-co-hexafluoropropylene) (PVdF-HFP), poly(tetrafluoroethylene) (PTFE), sodium carboxymethyl cellulose (CMC), styrene-butadiene rubber (SBR), nitrile butadiene rubber (NBR), styrene ethylene butylene styrene copolymer (SEBS), and combinations thereof.

18. The battery cell of claim 16, wherein:
the fibrillating polymer binder is selected from a group consisting of polytetrafluoroethylene (PTFE), fluorinated ethylene propylene (FEP), perfluoroalkoxy (PFA), ethylene tetrafluoroethylene (ETFE), or a combination thereof, and
the first conductive additive is selected from a group consisting of carbon black, graphite, graphene, graphene oxide, Super P, acetylene black, carbon nanofibers, carbon nanotubes, and combinations thereof.

19. The battery cell of claim 16, wherein:
the cathode electrode includes sulfide electrolyte in a range from 1 to 50 wt %, cathode active material in a range from 30 to 98 wt %, a conductive additive in a range from 1 to 30 wt %, and binder in a range from 1 to 20 wt %, and
the cathode electrode includes cathode active material selected from a group consisting of rock salt layered oxides, low voltage cathode material, and surface-coated active materials, doped cathode active materials and combinations thereof.

20. The battery cell of claim 19, wherein:
the conductive additive is selected from a group consisting of carbon black, graphite, graphene, graphene oxide, Super P, acetylene black, carbon nanofibers, carbon nanotubes and combinations thereof, and
the binder is selected from a group consisting of polytetrafluoroethylene (PTFE), sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), styrene butadiene styrene copolymer (SBS), and combinations thereof.
